(19) United States
(12) Patent Application Publication
(10) Pub. No.: US 2013/0074119 A1
(43) Pub. Date: Mar. 21, 2013

(54) MULTIMEDIA APPARATUS AND METHOD FOR CONTROLLING MULTIMEDIA APPARATUS

(71) Applicants: Myung Ryul Choi, Seoul (KR); Nag Eui Choi, Sawon-si (KR)

(72) Inventors: Myung Ryul Choi, Seoul (KR); Nag Eui Choi, Sawon-si (KR)

(21) Appl. No.: 13/616,155

(22) Filed: Sep. 14, 2012

(30) Foreign Application Priority Data
Sep. 19, 2011 (KR) 10-2011-093790

(51) Int. Cl. H04N 21/61; H04N 21/262; H04N 21/462; H04N 21/258

(52) U.S. Cl. 725/32; 725/127; 725/116; 725/131

(57) ABSTRACT

A multimedia apparatus may obtain a first signal including a multimedia signal, and a second signal input by a user, and simultaneously output the first signal and the second signal together. Accordingly, multimedia contents meeting user-friendly environments may be provided.

### CROSS-REFERENCE TO RELATED APPLICATION(S)

This application claims the benefit under 35 USC §119(a) of Korean Patent Application No. 10-2011-0093790, filed on Sep. 19, 2011, in the Korean Intellectual Property Office, the entire disclosure of which is incorporated herein by reference for all purposes.

### BACKGROUND

1. Field

The following description relates to a multimedia apparatus and a method for controlling the multimedia apparatus, and more particularly, to an apparatus that outputs and/or displays a multimedia signal and user data together.

2. Description of Related Art

As image processing technology expands, a variety of multimedia reproducing apparatuses are available including a digital video disc (DVD) player, a moving picture expert group (MPEG) layer 3 (MP3) player, and a compact disc (CD) player. In addition to these devices, portable multimedia players (PMP) are being developed and popularized.

A user may utilize various types of multimedia content such as video, audio, messages, and the like, through the use of such multimedia reproducing apparatuses. However, various multimedia devices including the multimedia reproduction apparatus are limited to simply receiving and displaying multimedia content provided from a content provider such as a broadcasting station or a network server.

That is, because of the unidirectional flow of the multimedia content from the content provider to a multimedia consumer, the consumer is unable to add his or her own content as desired to multimedia content that is currently being displayed.

KR Patent Laid-open No. 10-2007-0104134 describes a technology for transmitting an image corresponding to multimedia content and scene change control information of the image. In this technology, a receiving end may transform an image included in a broadcasting signal using scene change control information and display the image. However, the data displayed is still limited to data provided by the content provider.

### SUMMARY

In an aspect, there is provided a multimedia apparatus including a first signal unit configured to obtain a first signal comprising a multimedia signal, a second signal unit configured to obtain a second signal comprising a signal that is input by a user, and a signal output unit configured to simultaneously output the first signal and the second signal together.

The multimedia apparatus may further comprise a signal processing unit configured to generate a third signal by embedding the second signal in the first signal, wherein the signal output unit is configured to output the third signal.

The signal output unit may be included in a broadcasting server, and the broadcasting server may convert the third signal into a broadcasting signal and output the broadcasting signal.

The signal output unit may be included in a set-top box.

The second signal unit may comprise a receiving unit configured to receive the second signal from an external device.

The second signal unit may comprise an input unit configured to generate the second signal by receiving input from the user.

The second signal unit may comprise a storage unit configured to store the second signal, and an extraction unit configured to extract at least a portion of the second signal stored in the storage unit and transfer the extracted second signal to the signal output unit.

The multimedia apparatus may further comprise an address receiving unit configured to receive a network address of a display unit, wherein the signal output unit is configured to output the first signal and the second signal to the display unit corresponding to the network address.

The multimedia apparatus may further comprise a display area set unit configured to set a display area for the second signal on a display screen of a display unit that displays an output signal of the signal output unit, wherein the output signal of the signal output unit comprises setting information of the display area of the display unit.

The setting information of the display area may comprise at least one of preset setting information, setting information input from an external device, and setting information received from the external device.

The second signal may be displayed as an overlay of the first signal on a display screen.

The multimedia apparatus may further comprise a signal conversion unit configured to convert the second signal into a same type of signal as the first signal and transfer the converted second signal.

The first signal may comprise a format including at least one of national television system committee (NTSC), Phase Alternating Line (PAL), a cable broadcasting signal, a satellite broadcasting signal, a terrestrial broadcasting signal, a digital multimedia broadcasting (DMB) signal, a video codec, and an audio codec, and the signal conversion unit may be configured to convert the second signal into a signal of the same format as the first signal.

The second signal may comprise at least one of a short message service (SMS) message, a multimedia message service (MMS) message, advertisement data, and guide data.

In an aspect, there is provided a method for processing multimedia data, the method including receiving a first signal comprising a multimedia signal, and selectively receiving a second signal comprising a signal input by a user and simultaneously outputting the second signal together with the first signal, wherein the first signal is displayed on a screen, and the second signal is displayed on a predetermined area set in the screen.

The method may further comprise changing at least one of a position of the display area and a size of the display area, or selecting whether to display an overlay of the second signal with respect to the first signal.

In an aspect, there is provided a multimedia apparatus including a server configured to provide a multimedia signal, and a mode request unit configured to request the server for a first mode that outputs the multimedia signal to a display unit and a second mode that simultaneously outputs the multimedia signal and user data together to the display unit.

The mode request unit may comprise a data conversion unit configured to convert the user data into a same type of signal as the multimedia signal and transfer the converted user data to the server.

In another aspect, there is provided a control method for a multimedia apparatus, the control method including displaying a received multimedia signal on a display unit, and in response to a trigger signal being received, simultaneously displaying user data together with the multimedia signal on a display area set on a display screen of the display unit.

The trigger signal may be received at a time point designated by a user or a reception time point of the user data.

Other features and aspects will be apparent from the following detailed description, the drawings, and the claims.

### BRIEF DESCRIPTION OF THE DRAWINGS

FIG. 1 is a diagram illustrating an example of a multimedia apparatus.

FIG. 2 is a diagram illustrating another example of a multimedia apparatus.

FIG. 3 is a diagram illustrating another example of a multimedia apparatus.

FIG. 4 is a diagram illustrating another example of a multimedia apparatus.

FIG. 5 is a diagram illustrating an example of a receiving end of a multimedia apparatus.

FIG. 6 is a diagram illustrating an example of a transmitting end of a multimedia apparatus.

FIG. 7 is a flowchart illustrating an example of a control method for a multimedia apparatus.

FIG. 8 is a flowchart illustrating an example of a control method for another multimedia apparatus.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, the description of well-known functions and constructions may be omitted for increased clarity and conciseness.

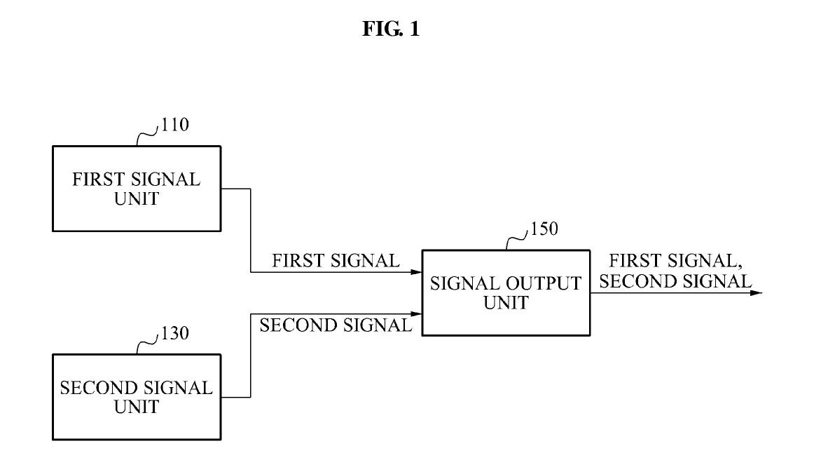

FIG. 1 illustrates an example of a multimedia apparatus.

Referring to FIG. 1, the multimedia apparatus includes a first signal unit 110 to obtain a first signal including a multimedia signal, a second signal unit 130 to obtain a second signal including a signal input by a user, and a signal output unit 150 to simultaneously output the first signal and the second signal together.

The multimedia signal may include multimedia data. For example, the multimedia may refer to various mediums including audio, text, images, video, and the like. Therefore, the multimedia data may include one or more of audio data, text data, image data, video data, and the like. The multimedia signal may refer to the multimedia data or a signal converted from the multimedia data to use various wired or wireless transmission paths.

The multimedia signal included in the first signal may include content that may not be changed by a user. For example, the multimedia signal may include a broadcasting signal transmitted from a broadcasting station, various multimedia data registered in a web server by a third-person user, multimedia data stored in a compact disc/digital versatile disc (CD/DVD), and the like. In some examples, the first signal may include a control signal for the multimedia signal.

The first signal may have a format of national television system committee (NTSC), Phase Alternating Line (PAL), a cable broadcasting signal, a satellite broadcasting signal, a terrestrial broadcasting signal, a digital multimedia broadcasting (DMB) signal, a video codec, an audio codec, and the like.

According to various aspects, it is possible to update content by the user with a second signal that includes user data. For example, the user data may include audio data, text data, image data, video data, multimedia data, and the like.

The first signal unit 110 may obtain the first signal that includes the multimedia signal. There are various methods by which the first signal unit 110 may obtain the first signal. For example, the first signal may be received from a broadcasting signal transmitted from a broadcasting station. The first signal may be extracted from a storage unit internally provided or from an external database (DB). As another example, the first signal may be generated using an input unit such as an internal or external multimedia authoring tool.

The second signal unit 130 may obtain the second signal input by the user and which includes the user data. Unlike the content of the first signal, the content of the second signal may be generated, changed, and/or updated by the user. For example, the second signal may include a short message service (SMS) message, a multimedia message service (MMS) message, advertisement data, guide data, and the like, each of which may include multimedia data such as images and audio data.

As an example, an SMS message and a MMS message may be a message to deliver to a family member. The advertisement data may be advertisement data generated by a small enterprise such as a restaurant. The guide data may be information data of a hospital.

The signal output unit 150 may receive the first signal from the first signal unit 110, receive the second signal from the second signal unit 130, and simultaneously output the first signal and the second signal together such that image data from the first signal is simultaneously displayed together with image data of the second signal.

Therefore, a receiving end of the signal output unit 150 may receive both the first signal and the second signal. If the receiving end is a multimedia apparatus that has a multimedia data reproduction function, such as a TV, an environment may be provided to display the first signal and the second signal together.

The first signal may be output from the signal output unit 150 through a pre-installed wired or wireless transmission line for a multimedia signal to various multimedia apparatuses such as a display reproduction apparatus. In this example, the signal output unit 150 may additionally output the second signal through the pre-installed transmission line. That is, the same wired or wireless transmission line may be used for both the second signal and the first signal. For example, if the first signal uses a channel of a predetermined frequency band, the second signal may also use the same channel.

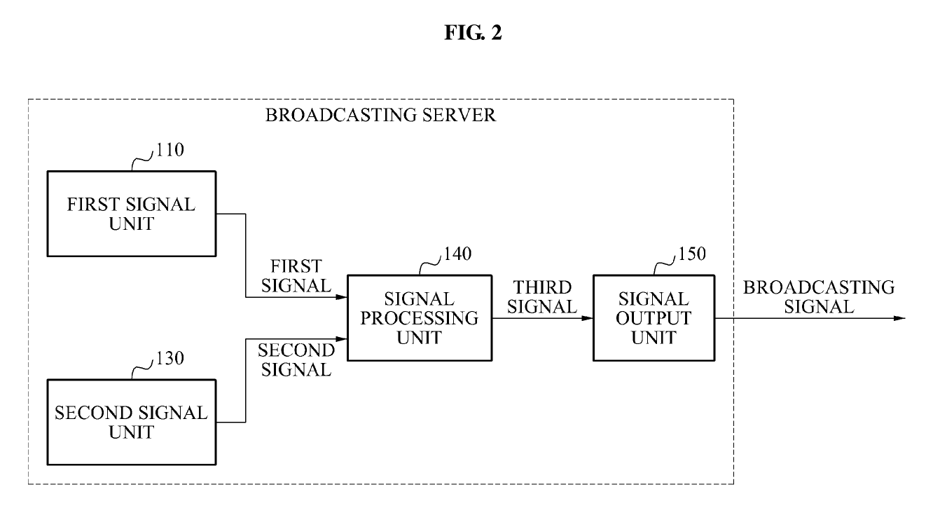

An output signal of the signal output unit 150 may include two signals, that is, the first signal and the second signal. A conventional multimedia reproducing apparatus that typically only receives the multimedia signal included in the first signal may is not able to receive and process the second signal. According to various aspects, the multimedia apparatus described herein may include a signal processing unit 140 as shown in FIG. 2 capable of simultaneously processing the first and second signals.

FIG. 2 illustrates another example of a multimedia apparatus.

Referring to FIG. 2, the multimedia apparatus includes a first signal unit 110, a second signal unit 130, a signal processing unit 140, and a signal output unit 150.

In this example, the signal processing unit 140 may generate a third signal by embedding a second signal obtained by the second signal unit 130 in a first signal obtained by the first signal unit 110. In addition, the signal output unit 150 may output the third signal instead of the first signal and the second signal.

The third signal, which refers to a combined signal of the first signal and the second signal, may use a signal type of the first signal to maintain use of the pre-installed transmission line for transmission of the multimedia signal. In this example, the signal processing unit 140 may convert a signal type of the third signal that is a combination of the first signal and the second signal into a signal type of the first signal. As another example, the second signal may be embedded in the first signal so that the third signal automatically has the signal type of the first signal.

The signal processing unit 140 and the signal output unit 150 described herein may output only the third signal having the same signal type as the first signal. As a result, a multimedia reproducing device that receives an output signal of the signal output unit 150 may reproduce and display the received third signal without an additional device. Such an effect is remarkable when the signal output unit 150 is included in a broadcasting server.

Referring to example of FIG. 2, the signal output unit 150 is included in a broadcasting server. In this example, the first signal unit 110, the second signal unit 130, and the signal processing unit 140 may or may not be included in the broadcasting server.

Irrespective of whether the first signal unit 110, the second signal unit 130, and the signal processing unit 140 are included in the broadcasting server, the third signal output from the signal processing unit 140 may be transferred to the signal output unit 150 included in the broadcasting server. Accordingly, the broadcasting server may include a broadcasting unit (not shown) to convert the third signal into a broadcasting signal and output the broadcasting signal. In this example, the broadcasting unit may be included in the signal output unit 150.

The broadcasting unit may generate the broadcasting signal by converting the third signal. Because a source input to the broadcasting unit is just the third signal, only conversion of the third signal is necessary in the same manner as when one piece of conventional multimedia data is converted into the broadcasting signal. Accordingly, a broadcasting unit may maintain its existing structure.

In various examples, the broadcasting server may transmit the converted broadcasting signal to a pre-installed antenna or in a conventional method through a pre-installed cable. Accordingly, the broadcasting server does not need a separate transmission line for the second signal and a separate broadcasting unit to convert the second signal into the broadcasting signal. In addition, the user may still use an existing display unit.

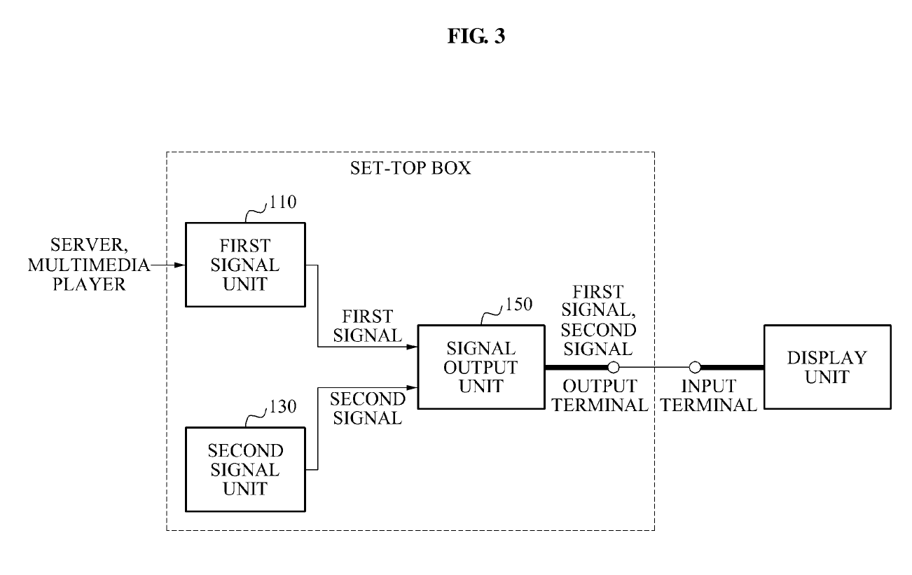

FIG. 3 illustrates another example of a multimedia apparatus. In this example, the signal output unit 150 is included in a set-top box instead of a broadcasting server.

Referring to FIG. 3, the multimedia apparatus includes a first signal unit 110, a second signal unit 130, and a signal output unit 150 installed in a set-top box. An output terminal of the signal output unit 150 may be connected to an input terminal of a display unit through the set-top box.

For example, the first signal unit 110 may obtain a first signal from multimedia providing servers such as a broadcasting server, a network server, and the like. As another example, the first signal may be obtained from various multimedia players such as a CD/DVD display, Blu-ray player, and the like. In addition, the first signal unit 110 may transmit the first signal to the signal output unit 150.

The output terminal of the signal output unit 150 may be connected to the input terminal of the display unit through the set-top box. For example, the set-top box may be equipped with an interface (not shown) connected to the output terminal of the signal output unit 150 with one end and to the input terminal of the display unit with the other end.

The output terminal of the signal output unit 150 and the input terminal of the display unit may be interconnected, for example, by a wire or by a wireless communication line. In this example, the output terminal of the signal output unit 150 and the input terminal of the display unit are interconnected one to one.

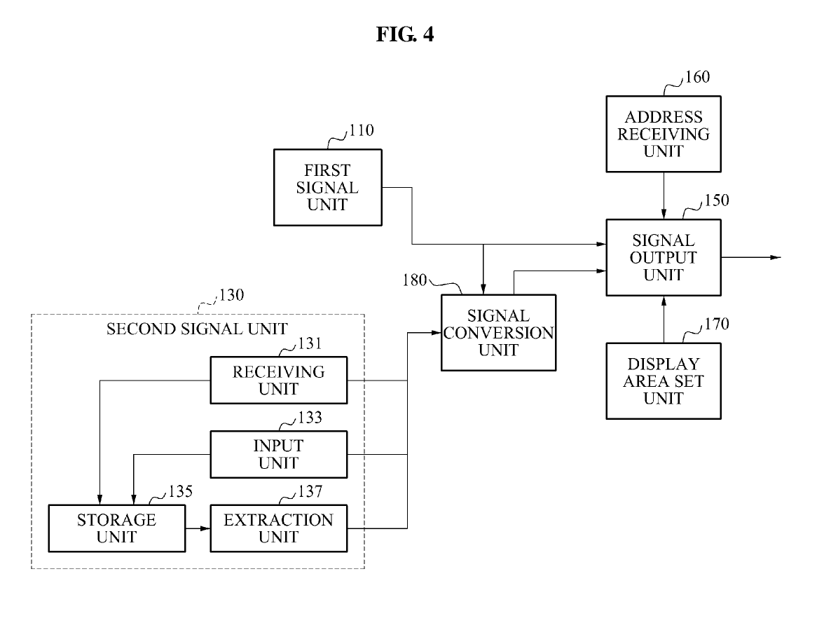

Because the signal output unit 150 and the display unit are interconnected, a target of the signal output from the signal output unit is clear. Therefore, the second signal output from the corresponding set-top box may be estimated as requested by the user of the display unit. In this example, a unit to select a target display unit of the second signal, for example, an address receiving unit 160 of FIG. 4 is not necessary. In addition, because the signal output unit 150 is included in the set-top box which is relatively more accessible for the user than the broadcasting server, the second signal unit may obtain the second signal from the user more efficiently.

FIG. 4 illustrates another example of a multimedia apparatus. As in the multimedia apparatuses of FIGS. 1 to 3, the multimedia apparatus includes a first signal unit 110, a second signal unit 130, and a signal processing unit 150. Also, a few additional structures are provided as further described herein.

Referring to FIG. 4, the second signal unit 130 includes a receiving unit 131 to receive the second signal. The receiving unit 131 may receive the second signal generated by an external device which generates and transmits the second signal. The receiving unit 131 may be configured to use a wired or wireless communication network corresponding to the external device. Thus, the second signal unit 130 may obtain the second signal by receiving the second signal from an outside device.

The second signal unit 130 includes an input unit 133 that generates the second signal by receiving input from a user. The input unit 133 may include a user input tool such as a keyboard, a multimedia authoring tool generating the second signal through operation of the user input tool, a check unit displaying the second signal to the user, a mouse, a touchpad, and the like. Thus, the second signal unit may obtain the second signal by generating the second signal through the input unit.

In addition, the second signal unit 130 may include a storage unit 135 to store the second signal and an extraction unit 137 to extract the second signal stored in the storage unit 135. The storage unit 135 may store at least one second signal. The second signal stored in the storage unit 135 may be transmitted from the receiving unit 131 or the input unit 133. The storage unit 135 may be separately structured from the second signal unit 130 and installed in the second signal unit 130 after the user stores the second signal. Various storage units such as a CD/DVD and Blu-ray discs are examples of the storage unit 135. The extraction unit 137 may extract at least a part of the second signal stored in the storage unit 135. The signal extracted by the extraction unit 137 may be a portion of or the entire second signal stored in the storage unit 135.

In addition, the multimedia apparatus may include an address receiving unit 160 to receive a network address of the display unit. In a system, for example, a broadcasting system that receives and displays the signal output from the signal output unit 150 by a plurality of display units, the second signal may be displayed together with the first signal even on a display unit that is not capable of displaying a signal of the second signal. The address receiving unit 160 may be used to prevent such a case. For example, the address receiving unit 160 may provide a received network address of the display unit to the signal output unit 150, so that the signal output unit 150 outputs the first signal and the second signal only on a display unit corresponding to the network address.

In this example, the address receiving unit 160 may receive a network address that demands the second signal. For example, a user may select to receive the second signal though a selection unit provided to the display unit, and the display unit may transmit the network address of the corresponding display unit to the address receiving unit 160. Also, the address receiving unit 160 may receive the network address of the display unit from a DB with which the network address demanding the second signal is registered.

The signal output from the signal output unit 150 may be used in various manners. For example, the signal output from the signal output unit 150 may be displayed on the display unit. Accordingly, the multimedia apparatus may include a display area set unit 170 to set a display area for the second signal on a display screen of the display unit.

The display unit that receives the first signal and the second signal output from the signal output unit 150 may display either or both of the first signal and the second signal. If the second signal is displayed together with or independently from the first signal, the display area set unit 170 may set an area to display the second signal on the display screen of the display unit. The output signal of the signal output unit 150 may include setting information of the display area for the second signal. According to various examples, the display unit may receive the setting information and display the second signal on the display area included in the setting information by analyzing the setting information.

For example, the setting information output from the signal output unit 150 may include at least one of preset setting information, setting information input from an outside device, setting information received from the outside device, and the like. The preset setting information may be stored in a storage unit in advance. The setting information input from the outside may be input through an input unit. The setting information received from the outside may be received by a receiving unit. In various examples, the storage unit, the input unit, and the receiving unit may be integrally formed with the storage unit 135, the input unit 133, and the receiving unit 131 of the second signal unit, respectively.

As an example, the first signal and the second signal may be displayed together on a screen. In this example, the second signal may be displayed as an overlay state on the display screen for the first signal. For example, the multimedia apparatus may include a signal conversion unit 180 to convert the second signal into a signal of the same signal type as the first signal and transfer the converted second signal. As one example, the first signal may include a multimedia signal used in a conventional display unit and the like. Therefore, if the signal type of the second signal becomes the same as the signal type of the first signal including the multimedia signal, the display unit may directly use the second signal without another separate unit.

For example, the first signal may have a format including at least one of NTSC, PAL, a cable broadcasting signal, a satellite broadcasting signal, a terrestrial broadcasting signal, a DMB signal, a video codec, and an audio codec, and the like. In this example, the signal conversion unit 180 may convert the second signal to the format of the first signal.

As another example, the first signal may have a plurality of signal types. In this example, the signal conversion unit 180 may judge the signal types of the first signal output together with the second signal. The signal conversion unit 180 may judge the signal types of the first signal by receiving the first signal obtained by the first signal unit.

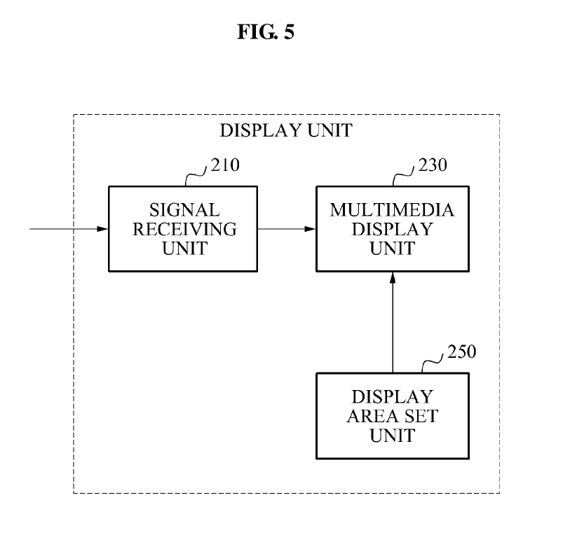

A display unit may receive the signal output from the signal output unit 150. The display unit may receive the first signal and display the first signal on a screen such as a panel. In addition, the display unit may selectively receive the second signal output from the signal output unit 150 together with the first signal. Also, the display unit may display the second signal on a display area set on the screen. An example of the display unit is shown in FIG. 5.

FIG. 5 illustrates an example of a receiving end of a multimedia apparatus.

Referring to FIG. 5, the multimedia apparatus includes a signal receiving unit 210 to receive a first signal and selectively receive a second signal output from a signal output unit along with the first signal. The multimedia apparatus also includes a multimedia display unit 230 to display the first signal and display the second signal on a display area set in a screen.

The signal receiving unit 210 may receive the first signal and also the second signal. Because the second signal may be additionally output from a signal output unit, the signal receiving unit 210 may include an antenna or a wired receiving unit capable of receiving the second signal as well as the first signal.

For example, the multimedia display unit 230 may extract the first signal and the second signal separately, and display the second signal on the set display area of the screen while simultaneously displaying the first signal on the screen. The first signal or the second signal may include audio data. Therefore, the multimedia display unit 230 may further include a speaker to output the audio data.

The display area of the screen to display the second signal may be set as default, or set using setting information received by the signal receiving unit 210. For example, the display area may be set by a display area set unit 250 provided to the multimedia display unit 230. The display area set unit 250 may enable a user of the multimedia apparatus of FIG. 5 to directly change a position and/or a size of the display area that is set for the second signal, or to select an overlay state of the second signal with respect to the first signal.

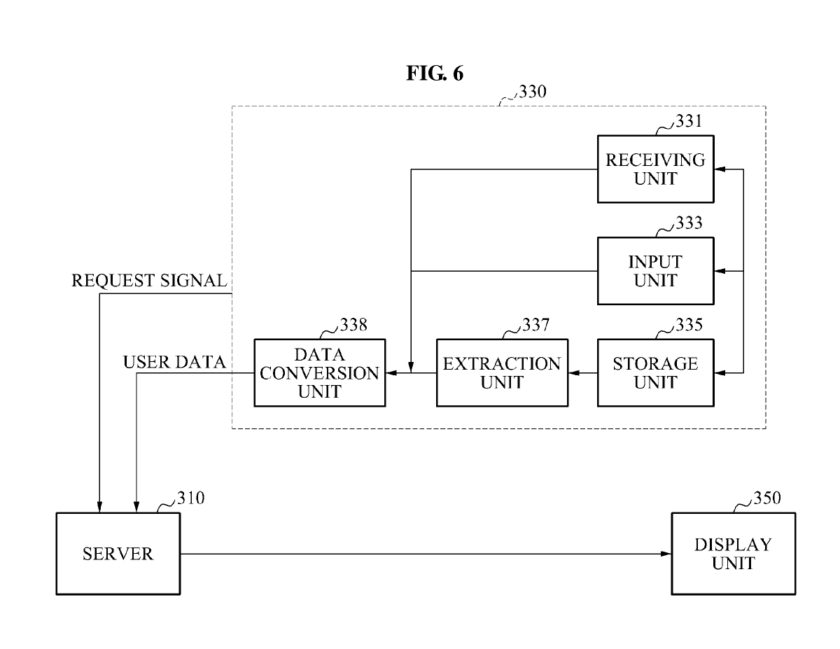

FIG. 6 illustrates an example of a received end of a multimedia apparatus.

Referring to FIG. 6, the multimedia apparatus includes a mode request unit 330 to request a server 310 that provides a multimedia signal to output the multimedia signal and user data together to a display unit 350.

The server 310 adapted to provide the multimedia signal may include a broadcasting server, a relay broadcasting server, a network content server, a private broadcasting server, a set-top box connected to the display unit 350, and the like. For example, the server 310 may be provided with a signal output unit to simultaneously output the multimedia signal and the user data.

The mode request unit 330 may generate a request signal to request the server 310 for a first mode to output the multimedia signal to the display unit 350 and a second mode to output the multimedia signal and the user data together to the display unit 350, and transmit the request signal to the server 310.

The server 310 may receive the request signal and analyze the request signal of the mode request unit 330 to determine whether the request is acceptable. For example, if the request is unacceptable, the server 310 may transmit a reject message to the mode request unit 330. If the request is acceptable, the server 310 may drive the signal output unit according to the mode contained in the request signal.

As an example, the server 310 may not accept the request of the mode request unit 330 in various cases. For example, the request may be unacceptable when the user data obtained is absent.

The mode request unit 330 may transmit at least one of user data received by a receiving unit 331, user data generated by an input unit 333, and user data extracted from a storage unit 335 by an extraction unit 337, to the server 310. The data stored in the storage unit 335 may be transmitted from a receiving unit or generated by an input unit and transmitted.

Information indicating that the user data desired to be output by the request signal of the second mode is the user data transmitted from the mode request unit 330 may be included in request information and may be transmitted to the server 310. In addition, the user data may be transmitted to the server 310. For example, the mode request unit 330 may include a data conversion unit 338 to convert the user data to a signal type of the multimedia signal and transmit the converted user data to the server 310, so as to reduce a load of the server 310.

The server 310 may receive the user data transmitted from the mode request unit 330 by a receiving unit provided to a second signal unit, and store the received user data according to the request or output through the signal output unit together with the multimedia signal.

As an example, the multimedia apparatus illustrated in FIG. 6 may be a portable terminal including a smart phone, a tablet personal computer (PC), a remote controller, and the like. Using the portable terminal, the user may easily output the multimedia signal and the user data to the display unit 350 and the like.

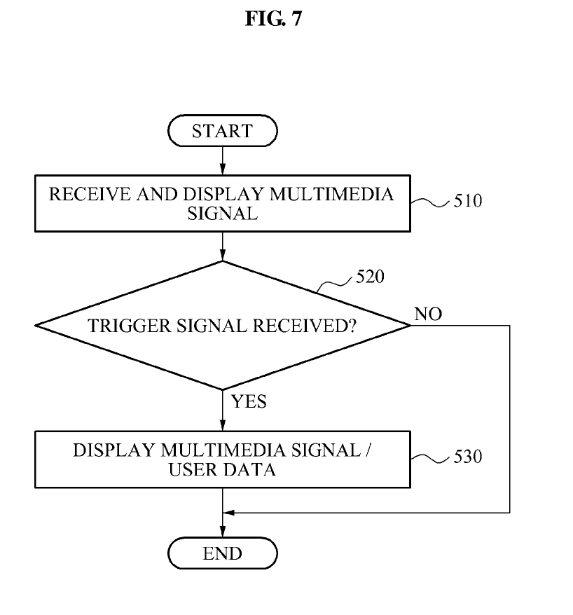

FIG. 7 illustrates an example of a control method of a multimedia apparatus. In this example, the user data may be displayed together with the multimedia signal at a desired point of time.

Referring to FIG. 7, in operation 510, a received multimedia signal is displayed on a display unit. For example, the display unit may be the multimedia apparatus shown in FIG. 5. The reception of the multimedia signal may be performed by the signal receiving unit 210 and display may be performed by the multimedia display unit 230.

A trigger signal is received in operation 520. In response, user data is displayed together with the multimedia signal on a display area set in a display screen of the multimedia display unit 230, in operation 530. For example, the user data may have a shorter display time than the multimedia signal. Therefore, a point of time to display the user data out of the display time of the multimedia signal may be a significant matter.

Therefore, a trigger generation unit (not shown) may be used. For example, the trigger generation unit may generate a trigger signal at a time point designated by the user or a time point of receiving the user data, and transmit the trigger signal to the multimedia display unit 230. The multimedia display unit 230 receiving the trigger signal may display the multimedia signal and the user data. If the trigger signal is not received, the multimedia display unit may display only the multimedia signal.

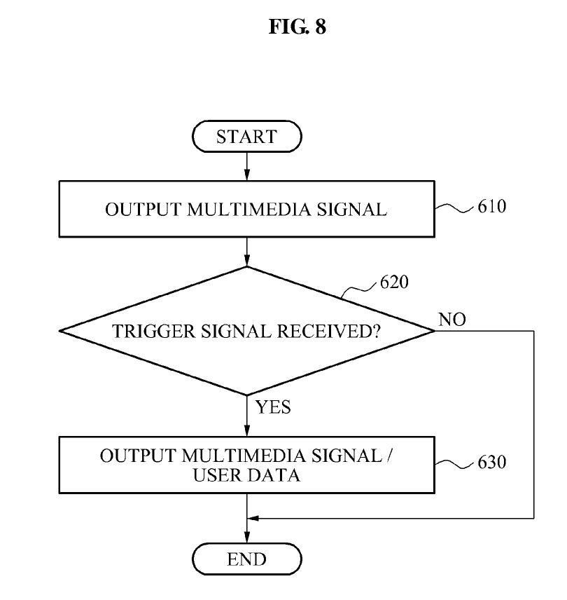

FIG. 8 illustrates another example of a control method for a multimedia apparatus. In this example, the user data may be output together with the multimedia signal at a desired point of time.

The control method illustrated in FIG. 8 may be explained with reference to operation of the multimedia apparatus of FIG. 1. First, a multimedia signal is output in operation 610. For example, the output may be performed by the first signal unit 110 and the signal output unit 150.

If a trigger signal is received from a trigger generation unit (not shown) in operation 620, the multimedia signal and user data are output together, in operation 630. In this example, the signal output unit 150 may output only the multimedia signal if the trigger signal is not received from the trigger generation unit. As another example, if the trigger signal is received from the trigger generation unit, the user data obtained from the second signal may be output together with the multimedia signal.

The trigger generation unit may generate the trigger signal at a time point designated by the user or a time point of receiving the user data.

According to various aspects, a multimedia apparatus is capable of creating a more convenient and enjoyable user experience by displaying a multimedia signal together with a user data signal through various types of multimedia devices.

It will be apparent to those skilled in the art that various modifications and variation can be made without departing from the spirit or scope of the embodiments. Therefore, it should be construed that foregoing general illustrations and following detailed descriptions are not limiting but exemplified. The range of the embodiments is defined by claims rather than the detailed description and is to be understood to include all changes and modifications deduced from meaning and range of claims and their equivalents. For example, when the signal output unit 150 of FIG. 3 matches a display unit one to one, the signal output unit 150 may include an n-number of output terminals (n denotes natural number) and match an n-number of the display units one to one. In this case, the signal output unit 150 may be configured to discriminate the n-number of types of user data and output the user data together with a multimedia signal to the respective output terminals.

The embodiments may be applied to an apparatus outputting a multimedia signal and user data together to another device.

In particular, the embodiments may be applied to a broadcasting server, a set-top box, and the like.

In addition, the embodiments may be applied to a display and the like that displays a received multimedia signal and user data.

Also, the embodiments may be applied to a terminal that requests output of a multimedia signal and user data together.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/device/multimedia apparatus described herein may refer to mobile devices such as a cellular phone, a personal digital assistant (PDA), a digital camera, a portable game console, and an MP3 player, a portable/personal multimedia player (PMP), a handheld e-book, a portable laptop PC, a global positioning system (GPS) navigation, a tablet, a sensor, and devices such as a desktop PC, a high definition television (HDTV), an optical disc player, a setup box, a home appliance, and the like that are capable of wireless communication or network communication consistent with that which is disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A multimedia apparatus comprising:
a first signal unit configured to obtain a first signal comprising a multimedia signal;
a second signal unit configured to obtain a second signal comprising a signal that is input by a user; and
a signal output unit configured to simultaneously output the first signal and the second signal together.

2. The multimedia apparatus of claim 1, further comprising:
a signal processing unit configured to generate a third signal by embedding the second signal in the first signal,
wherein the signal output unit is configured to output the third signal.

3. The multimedia apparatus of claim 2, wherein
the signal output unit is included in a broadcasting server, and
the broadcasting server converts the third signal into a broadcasting signal and outputs the broadcasting signal.

4. The multimedia apparatus of claim 1, wherein the signal output unit is included in a set-top box.

5. The multimedia apparatus of claim 1, wherein the second signal unit comprises a receiving unit configured to receive the second signal from an external device.

6. The multimedia apparatus of claim 1, wherein the second signal unit comprises an input unit configured to generate the second signal by receiving input from the user.

7. The multimedia apparatus of claim 1, wherein the second signal unit comprises:
a storage unit configured to store the second signal; and
an extraction unit configured to extract at least a portion of the second signal stored in the storage unit and transfer the extracted second signal to the signal output unit.

8. The multimedia apparatus of claim 1, further comprising:
an address receiving unit configured to receive a network address of a display unit,
wherein the signal output unit is configured to output the first signal and the second signal to the display unit corresponding to the network address.

9. The multimedia apparatus of claim 1, further comprising:
a display area set unit configured to set a display area for the second signal on a display screen of a display unit that displays an output signal of the signal output unit,
wherein the output signal of the signal output unit comprises setting information of the display area of the display unit.

10. The multimedia apparatus of claim 9, wherein the setting information of the display area comprises at least one of preset setting information, setting information input from an external device, and setting information received from the external device.

11. The multimedia apparatus of claim 1, wherein the second signal is displayed as an overlay of the first signal on a display screen.

12. The multimedia apparatus of claim 1, further comprising:
a signal conversion unit configured to convert the second signal into a same type of signal as the first signal and transfer the converted second signal.

13. The multimedia apparatus of claim 12, wherein
the first signal comprises a format including at least one of national television system committee (NTSC), Phase Alternating Line (PAL), a cable broadcasting signal, a satellite broadcasting signal, a terrestrial broadcasting signal, a digital multimedia broadcasting (DMB) signal, a video codec, and an audio codec, and
the signal conversion unit is configured to convert the second signal into a signal of the same format as the first signal.

14. The multimedia apparatus of claim 1, wherein the second signal comprises at least one of a short message service (SMS) message, a multimedia message service (MMS) message, advertisement data, and guide data.

15. A method for processing multimedia data, the method comprising:
receiving a first signal comprising a multimedia signal; and
selectively receiving a second signal comprising a signal input by a user and simultaneously outputting the second signal together with the first signal,
wherein the first signal is displayed on a screen, and the second signal is displayed on a predetermined area set in the screen.

16. The method of claim 15, further comprising:
changing at least one of a position of the display area and a size of the display area, or selecting whether to display an overlay of the second signal with respect to the first signal.

17. A multimedia apparatus comprising:
a server configured to provide a multimedia signal; and
a mode request unit configured to request the server for a first mode that outputs the multimedia signal to a display unit and a second mode that simultaneously outputs the multimedia signal and user data together to the display unit.

18. The multimedia apparatus of claim 17, wherein the mode request unit comprises a data conversion unit configured to convert the user data into a same type of signal as the multimedia signal and transfer the converted user data to the server.

19. A control method for a multimedia apparatus, the control method comprising:
displaying a received multimedia signal on a display unit; and
in response to a trigger signal being received, simultaneously displaying user data together with the multimedia signal on a display area set on a display screen of the display unit.

20. The control method of claim 19, wherein the trigger signal is received at a time point designated by a user or a reception time point of the user data.
